(19) United States
(12) Patent Application Publication
(10) Pub. No.: US 2025/0043824 A1
(43) Pub. Date: Feb. 6, 2025

(54) CAGE FOR ROLLING BEARINGS AND HIGH-SPEED BEARING FITTED WITH SUCH A CAGE

(71) Applicant: Aktiebolaget SKF, Göteborg (SE)

(72) Inventors: Piero SANTANGELO, Torino (IT); Riccardo RESTIVO, Torino (IT); Enzo AMICO, Moncalieri (IT); Giuseppe SARDELLA, Pinerolo (IT)

(21) Appl. No.: 18/775,584

(22) Filed: Jul. 17, 2024

(30) Foreign Application Priority Data
Aug. 1, 2023 (IT) 102023000016185

(51) Int. Cl. F16C 33/41; F16C 19/06; F16C 33/38

(52) U.S. Cl. CPC F16C 33/418; F16C 19/06; F16C 33/3831

(57) ABSTRACT

A rolling bearing (3) includes an annular cage (1) formed by two half-cages (9, 10) connected together using connection elements (14). The connection elements (14) include male elements (15), recesses (16) and metal inserts (18, 19). The male elements (15) are carried by a first half-cage (9) and each in the form of a substantially rigid block. The recesses (16) are formed in a second half-cage (10) and receive the male elements (15). First and second annular metal inserts (18, 19) are overmoulded with the first and second half-cages (9, 10) respectively and completely embedded inside respective annular bodies (11) thereof.

### CROSS-REFERENCE TO RELATED APPLICATION

This application claims priority to Italian Application No. 102023000016185, filed Aug. 1, 2023, the entirety of which is hereby incorporated by reference.

### FIELD

The present disclosure relates to a cage for high-speed rolling bearings and to a high-speed bearing fitted with such a cage.

### BACKGROUND

A rolling bearing comprising an outer ring, an inner ring and a plurality of rolling bodies (balls) interposed between the rings to make them relatively rotatable with low friction is known from DE1914884U. The rolling bodies are held in the correct position by a cage including:
a plurality of pockets or seats, each delimited by a respective spherical surface having a centre lying in a radial median plane coincident when in use with a corresponding radial median plane of the bearing,
two half-cages that are substantially symmetrical about the median plane and that are connected to each other, each half-cage having an annular body and a plurality of at least partially hemispherical cavities axially facing the hemispherical cavities of the opposing half-cage to define the pockets therewith, and
connection means associated with the half-cages to connect the two half-cages together.

Furthermore, for each half-cage, there are two substantially concentric and circumferentially continuous radial reliefs extending radially in opposite directions from each annular body, the first relief extending radially outwards to sealingly engage a groove formed in the outer ring of the bearing, and the second relief extending radially inwards to sealingly engage a groove formed in the inner ring of the bearing, said inner ring being split into two half-rings that are joined together.

A cage for rolling bearings made of two half-cages that are coupled together to form seats for the balls of the rolling bearing is known from JP2007040383A. The seats are formed by simple circular holes and the related connection means are mating snap-coupling elements in the form of dovetail joints or snap-coupling pins in respective cylindrical seats.

Both of the described solutions have the drawback that the cage, which is formed by coupling the two polymer half-cages together, may not be rigid enough to prevent the cage from being elastically deformed, when in use, by variations in the rotational speeds normally applied to rolling bearings when in use.

This drawback is mostly present in high-speed rolling bearings in which the possible speed variations are more pronounced and the maximum speeds may be very high, potentially 3 million NDM.

In these rolling bearings, the normal polymer cages formed by snap-coupling two half-cages together, as in JP2007040383A, may be deformed as the speed increases in all directions. In the radial direction, the cage expands, entailing a risk of the outer diameter thereof coming into contact with the outer ring of the rolling bearing, while in the tangential direction the seats or pockets containing the rolling bodies “open”, entailing a risk of losing holding power over the rolling bodies, in particular when said rolling bodies are balls, which can therefore come out. Furthermore, polymer cages are temperature-sensitive, and perform worse at temperatures greater than the glass transition temperature of the material they are made of (for the material PA66 this already occurs at 70-80° C.).

### SUMMARY

The present disclosure is therefore intended to overcome the drawbacks in the prior art, and in particular to provide a cage that enables the rolling bodies to be held correctly, eliminating potential noise, in particular at low speeds, and that simultaneously also correctly holds the rolling bodies at high speeds without generating unwanted contact between the cage and the outer ring of the rolling bearing, which would generate high friction, potentially damaging the cage, and generate excessive heat, which would further worsen the performance of the cage.

The present disclosure is also intended to provide a rolling bearing for high-precision, high-speed applications using such a cage.

The present disclosure therefore provides a cage for holding the rolling bodies in a high-speed rolling bearing, and a related rolling bearing unit, as defined in the attached claims.

The cage according to the present disclosure uses a double snap-coupling between two polymer half-cages in combination with a stiffening of both half-cages obtained using metal inserts having a specifically selected shape that are overmoulded with the half-cages so as to be embedded inside the annular body of each half-cage. Furthermore, according to a possible embodiment of the present disclosure, a more rigid connection between the two half-cages is obtained using rivets.

### BRIEF DESCRIPTION OF THE DRAWINGS

Further features and advantages of the present disclosure are set out more clearly in the following description of non-limiting embodiments thereof, provided with reference to the figures in the attached drawings, in which:

FIG. 1 is an exploded perspective schematic view of a rolling bearing according to the present disclosure,

FIG. 2 is a radially cut-away, schematic, magnified, perspective, three-quarter side view of the rolling bearing in FIG. 1 in an assembled state,

FIG. 3 is a schematic, highly magnified, perspective view taken radially from the inside of a circumferential portion of a cage for holding rolling bodies according to the present disclosure, partially cut away along a plane perpendicular to an axis of symmetry of the cage and of the rolling bearing in FIGS. 1 and 2,

FIGS. 4 and 5 are respective highly magnified schematic perspective views of details of the coupling between two half-cages intended to form the cage in FIG. 3 once joined together,

FIGS. 6 and 7 are respective schematic perspective views of two half-cages intended to form the cage in FIG. 3 once joined together,

FIG. 8 is a schematic perspective view of two metal inserts that can be coupled together axially and are intended to be embedded in respective annular bodies of the half-cages in FIGS. 6 and 7, and

FIG. 9 is a magnified schematic view of a detail, partially cut away along the same plane as in FIG. 3, of a possible embodiment of the cage according to the present disclosure.

### DETAILED DESCRIPTION

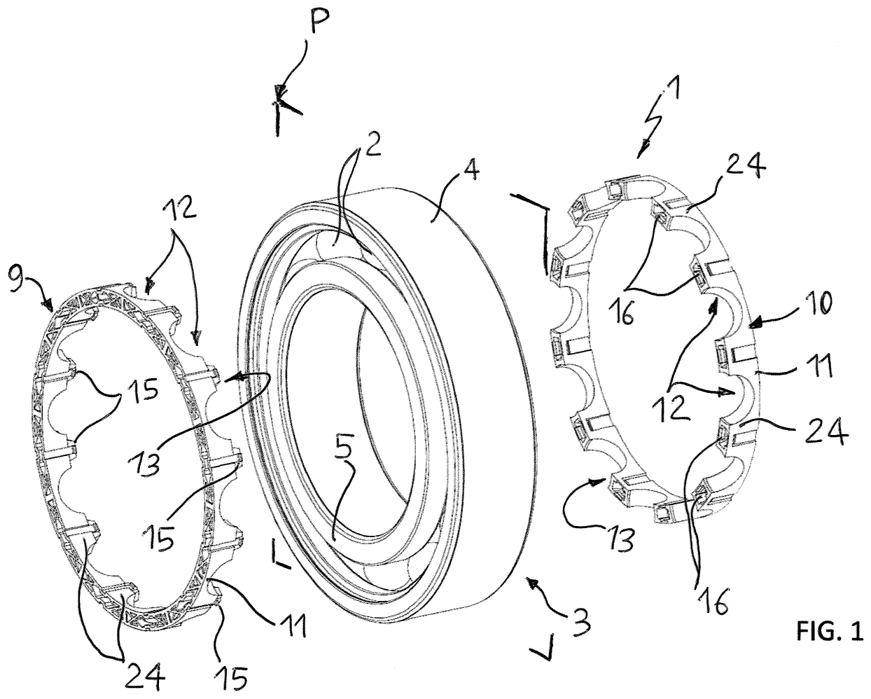

In FIGS. 1 to 8, reference sign 1 indicates, as a whole, a cage for holding rolling bodies 2 in a rolling bearing 3.

The bearing 3 is a precision rolling bearing for high speeds, comprising an outer ring 4, an inner ring 5, a plurality of rolling bodies 2 interposed between the outer ring 4 and the inner ring 5 to make them relatively rotatable with low friction, and the cage 1 for holding the rolling bodies 2 in the correct position. In the non-limiting example illustrated, and in any case according to the preferred embodiment of the present disclosure, the rolling bodies 2 are balls.

Hereinafter, “high-speed” means nominal rotational speeds of the rolling bearing 3 in the order of 2.5-3 NDM.

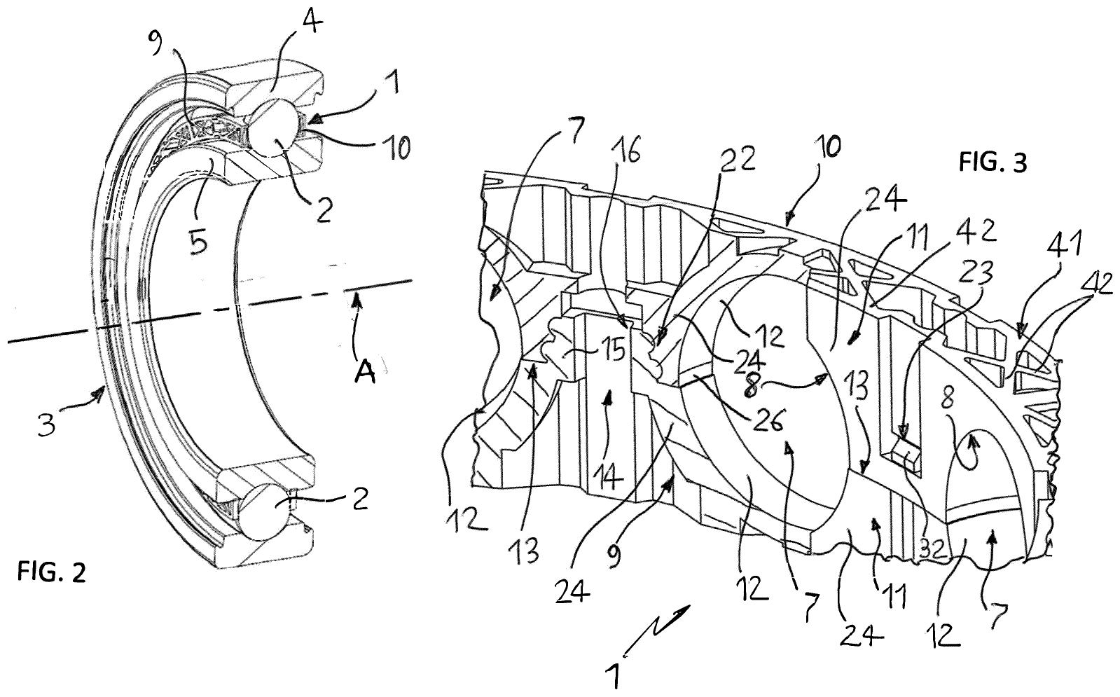

The cage 1 is designed to be interposed between the inner ring 5 and the outer ring 4 when in use and comprises a plurality of radial through-seats or pockets 7 (FIG. 3) disposed in a row, each being designed to seat a respective rolling body 2.

The radial through-seats or pockets 7 are each delimited by a respective curved surface 8, which is spherical in the illustrated embodiment (FIG. 3), having a centre lying in a radial median plane P (FIG. 1) of the cage 1 that is coincident when in use with a corresponding radial median plane of the rolling bearing 3.

The annular cage 1 comprises a first half-cage 9 and a second half-cage 10 arranged axially opposite one another.

The half-cages 9, 10 are rigidly connected together, as will be seen, and each has an annular body 11 and a plurality of at least partially curved cavities 12 (in this case at least partially spherical) formed on respective opposing first front faces 13 of the annular body 11 of each half-cage 9, 10.

The cavities 12 of the half-cages 9, 10 face one another. In particular, the at least partially curved cavities 12 in the first half-cage 9 axially face corresponding at least partially curved cavities 12 in the second half-cage 10 so as to define the seats or pockets 7 therewith, as illustrated in FIG. 3.

The annular cage 1 further comprises mechanical connection elements, indicated as a whole with reference sign 14 (FIG. 3), that are designed to rigidly connect the first and second half-cages 9, 10 together to form the annular cage 1.

According to a first feature of the present disclosure, the connection elements 14 comprise a plurality of respective male elements 15 (FIG. 5) carried by the first half-cage 9, each in the form of a substantially rigid block that projects axially from the front face 13 of the annular body 11 of the first half-cage 9, and a plurality of corresponding recesses 16 formed in the annular body 11 of the second half-cage 10 on the side of the first front face 13 thereof.

Each recess 16 is disposed in front of a corresponding male element 15 and is designed to be rigidly coupled to the substantially rigid block 15 forming the male element.

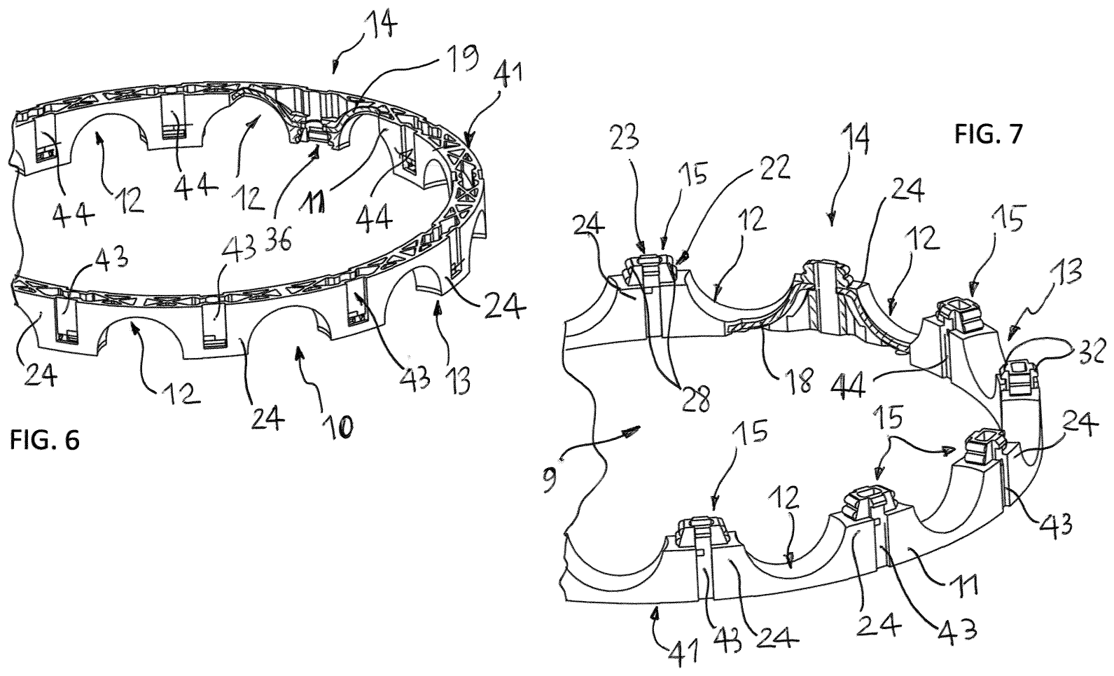

According to one aspect of the present disclosure, in combination with the foregoing, the connection elements 14 also comprise (FIGS. 6, 7 and 8) a first annular metal insert and a second annular metal insert, indicated respectively with reference signs 18 and 19.

According to one aspect of the present disclosure, the first annular metal insert 18 is overmoulded with the first half-cage 9 so as to be entirely embedded inside the annular body 11 of the half-cage 9, forming an annular stiffening frame.

Similarly, according to this aspect of the present disclosure, the second annular metal insert 19 is overmoulded with the second half-cage 10 so as to also be entirely embedded inside the annular body 11 of the half-cage 10, forming an annular stiffening frame.

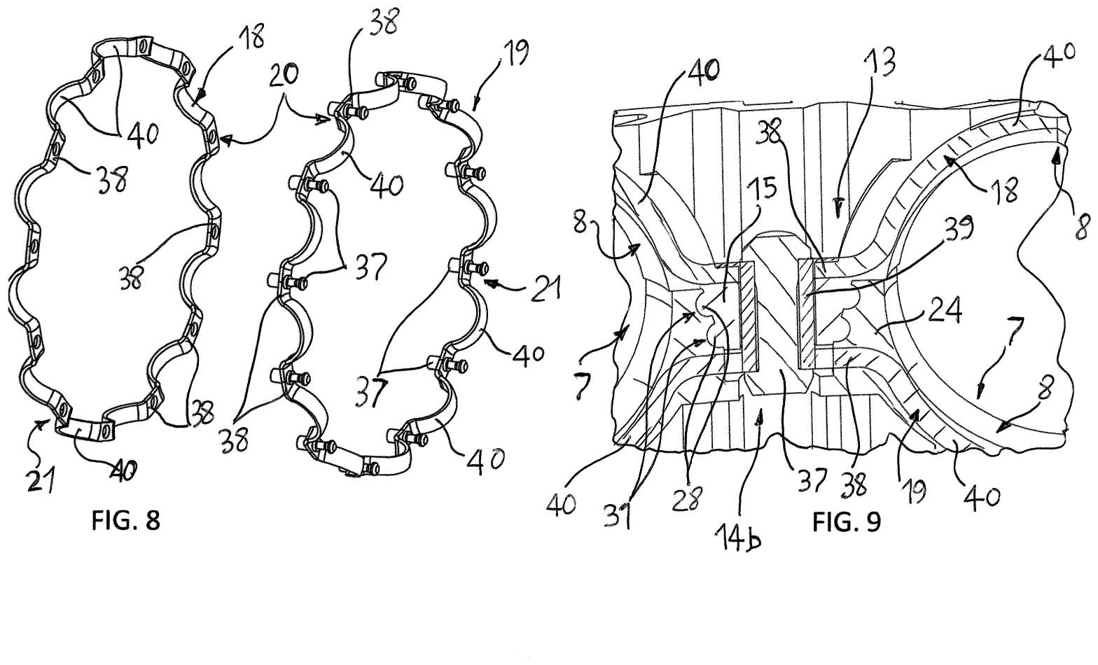

With reference to FIG. 8, the first and second annular metal inserts 18 and 19 are each delimited between an anterior front wall 20 facing the corresponding first front face 13 of each half-cage 9, 10 and a posterior front wall 21 opposite the anterior front wall 20, both walls being disposed perpendicularly to a shared axis of symmetry A (FIG. 2) of the cage 1 and of the rolling bearing 3, so that the first and second annular metal inserts 18, 19 are substantially washer-shaped.

According to an important aspect of the present disclosure, the first and second half-cages 9, 10 are joined together by circumferential couplings 22 and radial couplings 23 (FIGS. 3, 4 and 5) that are separate from one another and disposed axially in series, as set out in greater detail below.

In particular, the substantially rigid blocks 15 project axially from respective axial lugs 24 of the annular body 11 of the first half-cage 9.

The lugs 24 are formed on the first front face 13 of the half-cage 9. Similarly, the recesses 16 are preferably axial through-recesses and are formed inside corresponding axial lugs 24 of the second half-cage 10, which are also formed in this case on the first front face 13 thereof.

The axial lugs 24 of the first and second half-cages 9, 10 further delimit, on opposite sides, the seats or pockets 7 for the rolling bodies 2 and are coupled frontally in abutment so that the substantially rigid blocks 15 are inserted into the corresponding recesses 16, so that the cage 1, once assembled by connecting the half-cages 9, 10 together, is entirely symmetrical, with an optimum mass distribution (this is because the mass missing from the recesses 16 is compensated by the mass of the male elements 15), so that the centre of gravity of the cage 1 according to the present disclosure substantially coincides with the centre of gravity of the rolling bearing 3 with a tolerance of approximately 0.1 mm.

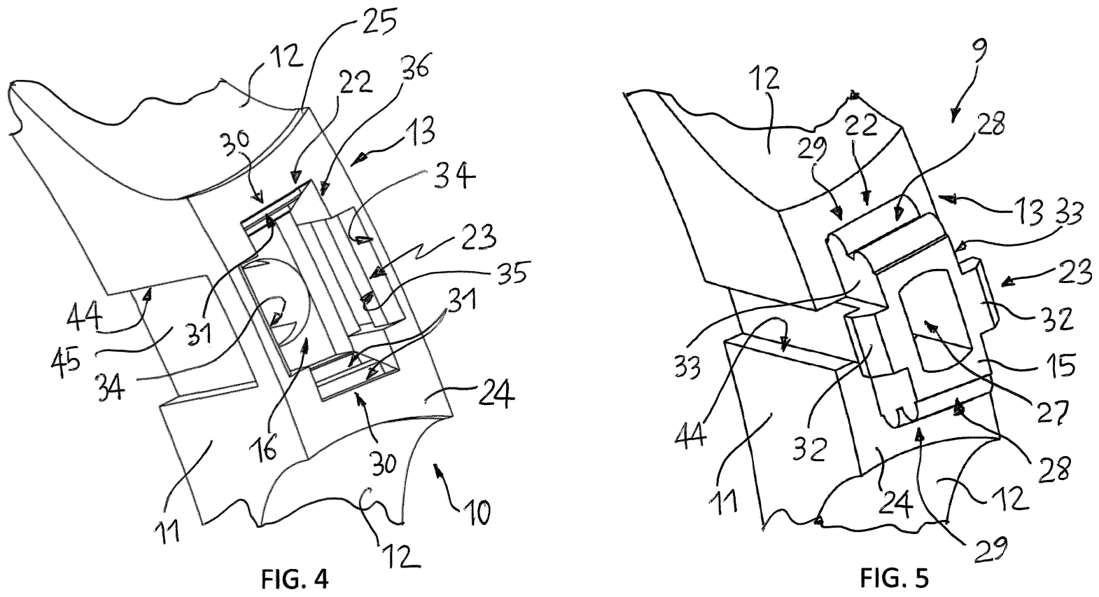

According to a preferred embodiment of the present disclosure (FIGS. 3 and 4), the opposing radial edges of the lugs 24 are provided with chamfers or rounded concavities 25 (FIG. 4) that form channels 26 (FIG. 3) inside the seats or pockets 7 at the abutment between the opposing lugs 24 of the half-cages 9 and 10, to enable the circulation of the lubricating grease.

Each male element formed by a substantially rigid block 15, which may be a solid block or a block provided with a through-hole 27 (FIG. 5), is provided (FIG. 5) with first fastening elements 28 in the form of a sequence of radial grooves or reliefs formed on circumferentially oriented opposing first side faces 29 of the block 15 in a radial direction.

Similarly (FIG. 4), the recesses 16 are provided, on circumferentially oriented opposing first side faces 30 thereof that are intended to face the first side faces 29 of a respective substantially rigid block 15 when the half-cages 9, 10 are coupled, with corresponding mating first fastening elements formed by a sequence of radial reliefs or grooves 31 (where a relief 28 corresponds to a groove 31, or vice versa) disposed axially in sequence.

The radial reliefs or grooves 31 of the recesses 16 are designed to snap-couple with corresponding radial grooves or reliefs 28 of the substantially rigid blocks 15. The reliefs or grooves 28, 31 thus together form the aforementioned circumferential couplings 22.

According to a non-secondary aspect of the present disclosure, each substantially rigid block 15 is also provided (FIG. 5) with second fastening elements formed by a pair of opposing teeth 32 that project radially from opposing second side faces 33 of each substantially rigid block 15, said side faces being disposed transversely to the first faces 29.

The first fastening elements 28 of each block or male element 15 are disposed axially in sequence and closer to the first face 13 of the annular body 11 of the first half-cage 9 than the second fastening elements formed by the teeth 32.

Similarly (FIG. 4), each recess 16 of the second half-cage 10 is provided, on opposing second side faces 34 thereof disposed transversely to the first side faces 30 thereof, with respective engagement seats 35 for the teeth 32 of the substantially rigid blocks 15 of the first half-cage 9.

The engagement seats 35 are disposed substantially flush with an opening 36 (FIGS. 4 and 6) of each recess 16 and further disposed axially in sequence with the sequence of radial reliefs or grooves 31 of the respective recess 16. In particular, the sequence of radial reliefs or grooves 31 of each recess 16 is disposed further away from the opening 36 than the engagement seats 35.

The engagement seats 35 and the teeth 32 thus form the aforementioned radial couplings 23 between the half-cages 9, 10.

According to another aspect of the present disclosure, the first and second annular metal inserts 18, 19 (FIG. 8) are not only embedded in the annular body 11 of each half-cage 9, 10, but are also connected mechanically together, preferably using respective rivets 37 that pass through respective first flat circumferential stretches 38 thereof.

When in use, i.e. when the cage 1 is assembled, the rivets 37 (FIG. 9) pass entirely through the axial lugs 24 at the first fastening elements 28, as they are inserted through the holes 27.

FIG. 9 shows a possible alternative embodiment 14b of the mechanical connection elements 14 described above.

According to this embodiment, the rivets 37 are seated in respective cylindrical bushings 39 passing entirely through the axial lugs 24, in this case fitted in the holes 27. This further increases the rigidity of the cage 1.

According to a possible variant of this embodiment in FIG. 9, which for the sake of simplicity is not illustrated, the cylindrical bushings 39 may preferably be tubular portions deep-drawn from corresponding first circumferential stretches 38 of the first and second annular metal inserts 18, 19. Said deep-drawn portions (not illustrated, for simplicity) are coupled together in abutment and seated through the axial lugs 24 of the first and second half-cages 9, 10, taking advantage of the holes 27 and the fact that the recesses 16 are preferably through-recesses.

Preferably, each substantially rigid block 15 forming a male element is a truncated pyramid, preferably with a rectangular base, as is each corresponding recess 16, so that the coupling between each substantially rigid block 15 and the corresponding recess 16 occurs via the side faces 29, 30 and 33, 34 thereof, which are disposed obliquely to the shared axis of symmetry A of the opposing half-cages 9, 10, said axis of symmetry A also being the axis of symmetry of the rolling bearing 3.

According to another aspect of the present disclosure, the first and second annular metal inserts 18, 19 (FIG. 8) are designed not only to be rigidly coupled together in the axial direction, preferably using rivets 37, but are also mirror symmetric in an axial direction and each have, in addition to a plurality of the aforementioned first substantially flat and straight circumferential stretches 38 arranged in a row, a plurality of second curved circumferential stretches 40 that alternate with the first flat circumferential stretches 38 so that each second stretch 40 is interposed between a pair of first adjacent stretches 38, and vice versa.

The second curved circumferential stretches 40 project axially from the first circumferential stretches 38 outside the main plane containing the annular metal inserts 18, 19 defined by the flat circumferential stretches 38, and are designed to mimic the circumferential profile of the curved surfaces 8 (FIG. 9) delimiting the seats or pockets 7 for the rolling bodies 2.

In particular, the circumferential stretches 40 are disposed in parallel and adjacent to the curved surfaces 8 such as to form circumferential hooping elements of the seats or pockets 7 for the rolling bodies 2, as clearly illustrated in FIG. 9, taking advantage of the fact that the first and second annular metal inserts 18, 19 are connected together at all of the first circumferential stretches 38 by respective rivets 37.

According to a final aspect of the present disclosure, the annular body 11 of each first and second half-cage 9 and 10 is delimited by a second front face 41 (FIG. 3) opposite the first front face 13.

This front face 41 is not flat and continuous, but is defined by a plurality of radial ribs 42 forming lattice elements. The ribs 42 cross one another and are formed as a single part on account of the fact that the half-cages 9, 10 are obtained by moulding a synthetic plastic.

The ribs 42 are thus able to impart greater radial rigidity on each half-cage 9, 10.

The polyamides PA66 and PA46, preferably reinforced with 25% or 30% fibreglass, are the preferred synthetic plastics for moulding the half-cages 9, 10, since it has been experimentally demonstrated that they couple better with the metal used to make the annular inserts 18, 19 (usually steel).

Finally, to facilitate snap-coupling between the elements 28 and 31, as well as snap-coupling between the elements 32, 35, at least the recesses 16 of the half-cage 10 are each flanked by a respective radially outer axial groove 43 and by a corresponding radially inner axial groove 44 formed in the annular body 11 so that each recess 16 is delimited at said axial grooves 43, 44 by elastically flexible walls 45 (FIG. 4).

Corresponding axial grooves 43, 44 are also preferably formed in the annular body 11 of the half-cage 9 to facilitate the snap-coupling of the teeth 32 in the engagement seats 35, thereby making the substantially rigid blocks 15 forming the male elements of the coupling 23 slightly elastically flexible only at the faces 33 (including as a result of the presence of the holes 27).

In accordance with the foregoing, it is clear that the scope of the present disclosure also covers a rolling bearing 3 comprising an outer ring 4, an inner ring 5 and a plurality of rolling bodies 2 interposed between the inner ring and the outer ring to make them relatively rotatable with low friction, characterized in that it further comprises an annular cage 1 for holding the rolling bodies 2 as described above, interposed between the inner ring 5 and the outer ring 4, i.e. formed by coupling two annular half-cages 9, 10 internally reinforced/stiffened by metal annular inserts 18, 19 and snap-coupled together and/or coupled together by rivets 37 passing through the metal inserts 18, 19.

An important aspect that confers the necessary rigidity is therefore the double snap-coupling provided at two axial points that are adjacent but separate (therefore axially in series) using the circumferential couplings 22 and the radial couplings 23.

Another important aspect is the presence of the curved stretches 40 that, on one hand, increase the rigidity of the half-cages 9, 10 at the seats or pockets 7 for the rolling bodies 2, preventing the “widening” thereof caused by the high rotation speeds of the rolling bearing 3, but which are also intended to act as a guide for the positioning of the metal inserts 18, 19 in the mould when carrying out the overmoulding operation to obtain the half-cages 9, 10, as well as to increase the mechanical engagement with the overmoulded polymer.

The entire assembled cage 1 is more rigid than a similar symmetrical polymer cage in the prior art. This helps to keep the deformations of the cage caused by very high speeds (2.5/3 million NDM) under control.

All of the objectives of the present disclosure are thus achieved.

What is claimed is:

1. An annular cage for retaining rolling bodies in a rolling bearing, the cage configured to be in use mounted interposed between respective inner and outer rings of the rolling bearing and comprising a plurality of radially passing-through seats or pockets arranged with respect to each other in a row and each configured to accommodate a respective rolling body, said plurality of radially passing-through seats or pockets being bounded, each, by a respective curved surface having a center lying in a radial median plane of the cage coincident in use with a corresponding radial median plane of the rolling bearing; said annular cage comprising:
a first and a second half-cage axially opposite to each other, said half-cages being connected to each other and each presenting an annular body and a plurality of cavities at least partially curved obtained on respective opposite first frontal faces of the annular body of each half-cage facing each other, said at least partially curved cavities of the first half-cage facing axially corresponding at least partially curved cavities of the second half-cage, so as to define with them said seats or pockets; and
mechanical connecting elements to rigidly connect to each other the first and second half-cages to form said annular cage, the mechanical connecting elements comprising:
a plurality of respective male elements carried by the first half-cage and configured, each, as a substantially rigid block projecting axially from said first frontal face of the annular body of the first half-cage;
a plurality of corresponding recesses formed in the annular body of the second half-cage on the side of said first frontal face of the same, each recess being arranged opposite to a said male element and configured to mate in integral manner with a corresponding substantially rigid block constituting the male element; and
first and second annular metal inserts, the first annular metal insert having been overmolded with the first half-cage so as to be completely embedded within the annular body of the first half-cage; and the second annular metal insert having been overmolded with the second half-cage so as to be completely embedded within the annular body of the second half-cage, the first and second annular metal inserts each being bounded between an anterior frontal wall facing the corresponding first frontal face of each half-cage and a posterior frontal wall, opposite to the anterior frontal wall, both walls arranged perpendicularly to an axis of symmetry of the cage, so that the first and second annular metal inserts are shaped substantially as washers.

2. The annular cage according to claim 1, wherein the first and second half-cages are constrained to each other by means of circumferential and radial couplings that are independent of each other and arranged axially in series.

3. The annular cage according to claim 1, wherein said substantially rigid blocks project axially from respective axial lugs of the annular body of the first half-cage formed on the first frontal face thereof; and in that said recesses are preferably axial through-recesses and are formed within corresponding axial lugs of the second half-cage formed on the first frontal face thereof; the axial lugs of the first and second half-cages delimiting on opposite sides the seats or pockets for the rolling bodies and being frontally coupled head to head to each other, so that said substantially rigid blocks are inserted into the corresponding said recesses.

4. The annular cage according to claim 3, wherein each said substantially rigid block is provided with first fastening elements consisting of a sequence of radial reliefs or grooves formed on opposite first lateral faces of the substantially rigid block in a radial direction; and in that said recesses are provided on opposite first lateral faces thereof, facing the first lateral faces of a respective substantially rigid block, with a sequence of radial reliefs or grooves arranged axially in sequence, said radial reliefs or grooves of the recesses being configured to snap-couple with corresponding radial grooves or reliefs of a corresponding substantially rigid block.

5. The annular cage according to claim 4, wherein each said substantially rigid block is further provided with second fastening elements comprising a pair of opposite teeth protruding radially from opposite second lateral faces of the substantially rigid block arranged transversely to the first faces, the first fastening elements being arranged axially in sequence and closer to the first face of the annular body of the first half-cage than the second fastening elements; and in that each said recess is also provided on its opposite second lateral faces arranged transversely to said first lateral faces thereof, with respective attachment seats for said teeth of the substantially rigid blocks of the first half-cage; said attachment seats being arranged substantially flush with an inlet opening of each recess and being further arranged axially in sequence with said sequence of radial reliefs or grooves of the respective recess, said sequence of radial reliefs or grooves of each recess being arranged farther away from said inlet opening than said attachment seats.

6. The annular cage according to claim 4, wherein said first and second annular metal inserts are connected to each other by respective rivets, which pass through respective first flat circumferential stretches of the metal inserts as well as through said axial lugs, in correspondence with said first fastening elements; said rivets being housed within respective cylindrical bushings fitted passing through said axial lugs; said cylindrical bushings consisting preferably of deep-drawn tubular portions of said first circumferential stretches of the first and second annular metal inserts coupled together head to head and housed through said axial lugs of the first and second half-cages.

7. The annular cage according to claim 1, wherein said first and second annular metal inserts are configured to be rigidly coupled in the axial direction to each other, preferably by rivets.

8. The annular cage according to claim 1, wherein said first and second annular metal inserts are mirror symmetrical in an axial direction and each comprise a plurality of substantially flat and straight first circumferential stretches arranged in a row and a plurality of curved second circumferential stretches arranged alternately with the first circumferential stretches, so that each second stretch is interposed between a pair of adjacent first stretches and vice versa; the second stretches projecting axially from the first stretches and being configured so as to reproduce a circumferential profile of said curved surfaces delimiting said seats or pockets for the rolling bodies and being arranged parallel and adjacent to said curved surfaces, so as to constitute circumferential hoop elements of the seats or pockets for the rolling bodies; said first and second annular metal inserts being connected to each other at all said first circumferential stretches.

9. The annular cage according to claim 1, wherein said annular body of each of said first and second half-cages is bordered by a second frontal face, opposite to the first face, which is defined by a plurality of radial ribs configured as lattice elements to impart greater radial stiffness to each of the first and second half-cages; and in that at least said recesses of the second half-cage are flanked, each, by a respective radially outer axial groove and a corresponding radially inner axial groove formed in the annular body, so that each said recess is bounded at said axial grooves, by elastically flexible walls.

10. The annular cage according to claim 2, wherein said substantially rigid blocks project axially from respective axial lugs of the annular body of the first half-cage formed on the first frontal face thereof; and in that said recesses are preferably axial through-recesses and are formed within corresponding axial lugs of the second half-cage formed on the first frontal face thereof; the axial lugs of the first and second half-cages delimiting on opposite sides the seats or pockets for the rolling bodies and being frontally coupled head to head to each other, so that said substantially rigid blocks are inserted into the corresponding said recesses.

11. The annular cage according to claim 10, wherein each said substantially rigid block is provided with first fastening elements consisting of a sequence of radial reliefs or grooves formed on opposite first lateral faces of the substantially rigid block in a radial direction; and in that said recesses are provided on opposite first lateral faces thereof, facing the first lateral faces of a respective substantially rigid block, with a sequence of radial reliefs or grooves arranged axially in sequence, said radial reliefs or grooves of the recesses being configured to snap-couple with corresponding radial grooves or reliefs of a corresponding substantially rigid block.

12. The annular cage according to claim 11, wherein each said substantially rigid block is further provided with second fastening elements comprising a pair of opposite teeth protruding radially from opposite second lateral faces of the substantially rigid block arranged transversely to the first faces, the first fastening elements being arranged axially in sequence and closer to the first face of the annular body of the first half-cage than the second fastening elements; and in that each said recess is also provided on its opposite second lateral faces arranged transversely to said first lateral faces thereof, with respective attachment seats for said teeth of the substantially rigid blocks of the first half-cage; said attachment seats being arranged substantially flush with an inlet opening of each recess and being further arranged axially in sequence with said sequence of radial reliefs or grooves of the respective recess, said sequence of radial reliefs or grooves of each recess being arranged farther away from said inlet opening than said attachment seats.

13. The annular cage according to claim 11, wherein said first and second annular metal inserts are connected to each other by respective rivets, which pass through respective first flat circumferential stretches of the metal inserts as well as through said axial lugs, in correspondence with said first fastening elements; said rivets being housed within respective cylindrical bushings fitted passing through said axial lugs; said cylindrical bushings consisting preferably of deep-drawn tubular portions of said first circumferential stretches of the first and second annular metal inserts coupled together head to head and housed through said axial lugs of the first and second half-cages.

14. The annular cage according to claim 12, wherein said first and second annular metal inserts are configured to be rigidly coupled in the axial direction to each other, preferably by rivets.

15. The annular cage according to claim 14, wherein said first and second annular metal inserts are mirror symmetrical in an axial direction and each comprise a plurality of substantially flat and straight first circumferential stretches arranged in a row and a plurality of curved second circumferential stretches arranged alternately with the first circumferential stretches, so that each second stretch is interposed between a pair of adjacent first stretches and vice versa; the second stretches projecting axially from the first stretches and being configured so as to reproduce a circumferential profile of said curved surfaces delimiting said seats or pockets for the rolling bodies and being arranged parallel and adjacent to said curved surfaces, so as to constitute circumferential hoop elements of the seats or pockets for the rolling bodies; said first and second annular metal inserts being connected to each other at all said first circumferential stretches.

16. The annular cage according to claim 15, wherein said annular body of each of said first and second half-cages is bordered by a second frontal face, opposite to the first face, which is defined by a plurality of radial ribs configured as lattice elements to impart greater radial stiffness to each of the first and second half-cages; and in that at least said recesses of the second half-cage are flanked, each, by a respective radially outer axial groove and a corresponding radially inner axial groove formed in the annular body, so that each said recess is bounded at said axial grooves, by elastically flexible walls.

17. A rolling bearing comprising:
an outer ring;
an inner ring;
a plurality of rolling bodies interposed between the inner and outer rings to make them relatively rotatable with respect to each other with low friction; and
an annular cage for retaining the rolling bodies according to claim 1, the cage being mounted interposed between the inner and outer rings.

18. A rolling bearing comprising:
an outer ring;
an inner ring;
a plurality of rolling bodies interposed between the inner and outer rings to make them relatively rotatable with respect to each other with low friction; and
an annular cage for retaining the rolling bodies according to claim 16, the cage being mounted interposed between the inner and outer rings.
